(19) United States
(12) Patent Application Publication
(10) Pub. No.: US 2010/0246187 A1
(43) Pub. Date: Sep. 30, 2010

(54) FLOODLIGHT

(75) Inventors: Norihito Yoshimori, Tokyo (JP); Masayuki Taguchi, Tokyo (JP); Atsushi Oonishi, Tokyo (JP); Kikuo Yamamoto, Tokyo (JP)

Correspondence Address: J. Rodman Steele;Novak Druce & Quigg LLP, 525 Okeechobee Blvd, Suite 1500, West Palm Beach, FL, 33401, US

(73) Assignee: Lightboy co. ltd, toyko (JP)

(21) Appl. No.: 12/528,722

(22) PCT Filed: Nov. 20, 2007
(86) PCT No.: PCT/JP2007/072438

§ 371 Date: Jan. 26, 2010

(30) Foreign Application Priority Data
Sep. 26, 2007 (JP) 2007 248537

(51) Int. Cl. F21V 29/00

(52) U.S. Cl. 362/294

(57) ABSTRACT

A floodlight including an electronic ballast which makes the floodlight easier to handle. A floodlight 1 comprises: a base 5; a telescopic mast 4 having a proximal end connected with said base 5; a lighting device 2 provided at a distal end of said mast 4; and an electronic ballast 3 that stabilizes electric power and feeds the stabilized electric power to said lighting device 2. The lighting device 2 includes a lamp 21 and a holding assembly 20 that holds said lamp 21, while the electronic ballast 3 is installed in said holding assembly 20.

### TECHNICAL FIELD

The present invention relates to a floodlight, specifically relates to one comprising an electronic ballast.

### BACKGROUND ART

Conventionally, as a floodlight of this kind is disclosed a floodlight comprising: a trolley serving as a base; a generator mounted on said trolley; a mast telescopically erected on said trolley; a balloon light source serving as a lighting device supported by said mast; and an electronic ballast for lighting up said balloon light source (for example, see patent document 1).

The electronic ballast comprises a copper-iron ballast, including a choke coil having a copper wire wound around an iron core, said copper iron ballast being made electronically controllable using an inverter or thyristor control circuit.

According to the electronic ballast made up as above, electronic components of the control circuit generate heat in association with the supply of electric power to the balloon light source. Therefore, it has heretofore been necessary to provide the electronic ballast with heat dissipating means such as a cooling fan and a heat sink block, in order to prevent the rise of temperature caused by the heat from the electronic components. This, however, has caused the electronic ballast to have heavy weight and large volume as a whole, having compelled the same to get large-sized. For example, an electronic ballast of 400 W weighs as heavy as about 4 to 5 kg.

In the past, such electronic ballast has ensured safety and stability in operating a floodlight by mounting the electronic ballast on a trolley relatively near the ground.

### Patent Document 1: Japanese Unexamined Patent Application Publication No, 2005-322587

### DISCLOSURE OF THE INVENTION

### Problems to be Solved by the Invention

According to the prior art disclosed in the foregoing patent document 1, however, the electronic ballast, in some cases, has had difficulties in handling and transporting the same due to its heavy weight and large size. There have also been problems that the electronic ballast may get in the way and impair the appearance when it is placed either on a trolley or directly on a floor in some cases. In addition, the conventional floodlights have had the electronic ballast placed on a trolley relatively near the ground and thus a distance from the electronic ballast to the balloon light source gets so long that there arises the need of a longer cable for electrically connecting the former to the latter, even causing some concerns that the balloon light source may not light up due to voltage drop becoming to great.

In view of the above-mentioned, it is, therefore, an object of the invention to provide a floodlight including an electronic ballast capable of being easily handled.

### Means for Solving the Problems

In order to achieve the above object, a floodlight according to a first aspect of the invention is characterized in comprising:

a base; a telescopic mast having a proximal end connected with said base; a lighting device provided at a distal end of said mast; and an electronic ballast that stabilizes electric power and feeds the stabilized electric power to said lighting device,
wherein said lighting device comprises;

a lamp; a holding assembly that holds said lamp; a balloon; a blower that feeds air into said balloon; and a vent hole that communicates an inside of said balloon with an outside thereof, and

wherein said holding assembly holds said balloon in the center thereof, and comprises: a socket portion that holds said lamp; a blower holding portion that holds said blower; and a ballast installing portion for installing said electronic thereon.

The floodlight according to a second aspect of the invention is characterized in that said ballast installing portion holds said electronic ballast in the course of an airflow passage of the air fed by said blower from the outside of the balloon through said vent hole.

The floodlight according to a third aspect of the invention is characterized in that said ballast installing portion comprises a communicating hole that communicates said vent hole with said electronic ballast.

### EFFECTS OF THE INVENTION

According to the floodlight set forth in the first aspect of the present invention, the electronic ballast is not exposed to the outside, thus enabling it to be easily transported, while improving the appearance.

According to the floodlight set forth in the second aspect of the present invention, the electronic ballast can be cooled down by the air fed into the balloon by the blower.

According to the floodlight set forth in the third aspect of the present invention, the outside air fed from the vent hole can be fed directly to the electronic ballast, thereby enabling the electronic ballast to be effectively cooled down.

### BRIEF DESCRIPTION OF THE DRAWINGS

FIG. 1 is a perspective view showing an overall structure of a floodlight according to the present invention.

FIG. 2 is a longitudinal sectional view showing a structure of a lighting device of the floodlight of FIG. 1.

FIG. 3 is a schematic view of an electronic ballast of the floodlight of FIG. 1, in which FIG. 3(A) is a front view thereof, while FIG. 3(B) is a right side view thereof.

### BEST MODE FOR CARRYING OUT THE INVENTION

Next is a description of preferred embodiments of the present invention, with reference to the attached drawings.

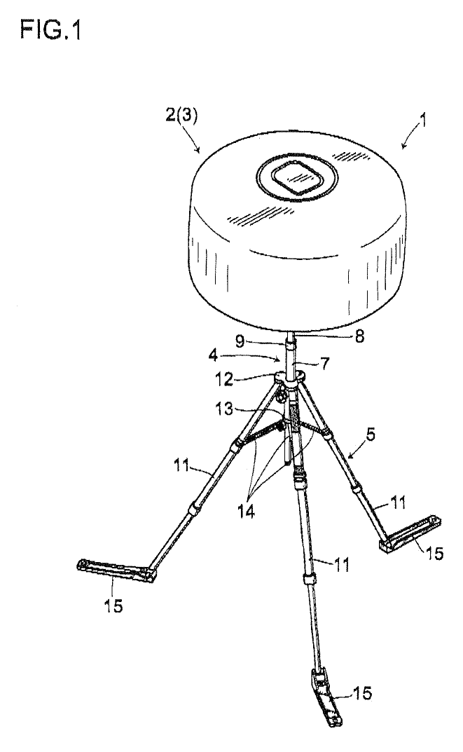

A floodlight 1 shown in FIG. 1 comprises: a lighting device 2; an electronic ballast 3; a telescopic mast 4; and a tripod 5 as a base. The floodlight 1 is constructed such that after it is conveyed to a suitable place, the tripod 5 is then set up to hold the lighting device 2 at a predetermined height, using the mast 4, and then electric power is supplied to the lighting device 2 from an electric power unit (not shown) through the electronic ballast 3, thus enabling the floodlighting of the surroundings.

The mast 4 comprises a plurality of vertically-erected metallic tubular columns (two columns in FIG. 1). The tubular columns include a first tubular column 7 arranged at a proximal end and a second tubular column 8 having a smaller outer diameter than the first tubular column 7 and inserted thereinto. The first tubular column 7 is provided with a fixing part 9 so that the second column 8 may be fixedly held at a predetermined height. The lighting device 2 is coupled to the distal end of the second column 8.

The tripod 5 comprises: three metallic legs 11; a first annular portion 12 that connects first ends of the three legs 11 in such a manner that they can simultaneously move in a length direction of the mast 4 along the same; and a second annular portion 13 connected to intermediate portions of the legs 11 in such a manner that they can move in the length direction of the mast 4 along the same. The first annular portion 12 allows the mast 4 to be inserted thereinto, and axially supports the legs 11. The second annular portion 13 allows the mast 4 to be inserted thereinto below the first annular portion 12, and connected with the intermediated portions of the legs 11 through links 14. Thus way, the tripod 5 is provided so as to be unfoldable radially around the first annular portion 12.

The first and second annular portions 12, 13 are held in a fixed position relative to the first tubular column 7 by the fixing means, thus enabling the legs 11 to be fixed at desirable angles relative to the tubular columns. The tripod 5 holds said mast 4 in the vertical direction in this way. On the other hand, there are provided grounding portions 15 at the second ends of the legs 11 so as to be capable of stably holding the tripod by the increased friction against the ground. In the illustrated example, the legs 11 are formed telescopic with a plurality of tubular columns being nested inside one another.

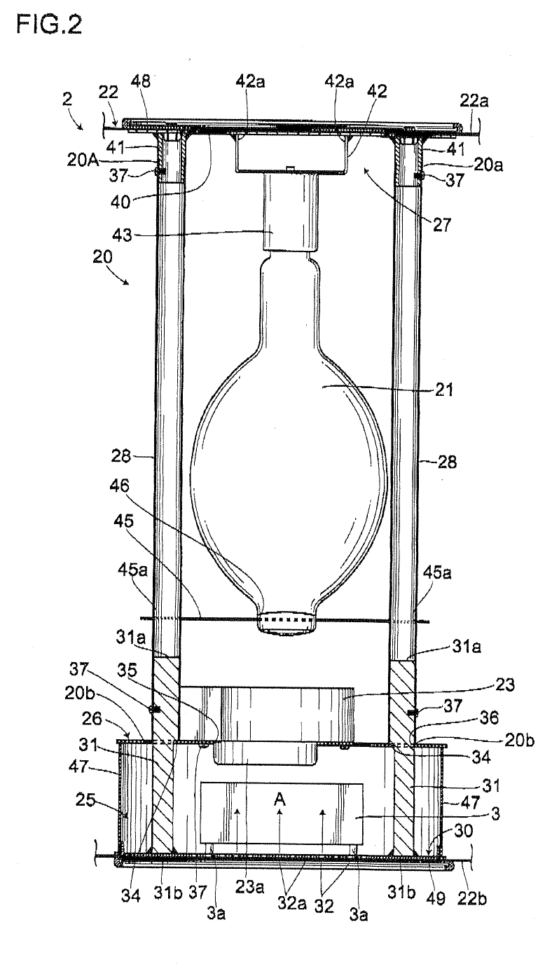

As shown in FIG. 2, the lighting device 2 comprises: a holding assembly 20, a lamp 21; a balloon 22; and a blower 23 that feeds air into said balloon 22. Said electronic ballast 3 is installed in said holding assembly 20. The lighting device 2 is provided with vent holes 32 for communicating an interior of the balloon 22 with an exterior thereof.

The holding assembly 20 is formed from metal members, and comprises a ballast installing portion 25, a blower retainer 26, a socket portion 27, and two or more support columns 28 (four in the present embodiment). The holding assembly 20 is constituted by stacking the ballast installing portion 25, the blower retainer 26, and the socket portion 27 in that order, and unifying them together by the tubular support columns 28. The holding assembly 20 constituted thus way is installed in the center of the balloon 22 to hold opposite ends of said balloon 22.

The ballast installing portion 25 comprises a first end plate 30 and two or more first axial bodies 31 (four in the present embodiment). The first end plate 30 is constituted by forming a metal plate in a shape of a cylinder with a bottom by means of press working. The first end plate 30 is formed in its bottom with a plurality of communication holes 32a as well as a plurality of through-holes for inserting a bolt therethrough (not shown). The communication holes 32a are each in fluid communication with the vent holes 32. This ballast installing portion 25 is mounted in the center of a first side of the first end plate 30 and fixed thereto by inserting a bolt into said through-hole from a second side and screwing the same into a tap hole (not shown) formed in a leg 3a of the electronic ballast 3.

The first axial body 31 is formed so as to comprise an anterior portion 31a having a comparatively large outside diameter and a posterior portion 31b having a comparatively small diameter, said anterior and posterior portions being demarcated by a substantial center in the length direction of the first axial body 31. An abutting step 34 is provided in the substantial center in the length direction.

The blower retainer 26 comprises a metal plate, a blower installing hole 35 and a first axis insertion hole 36 formed therethrough. The blower 23 is fixed to the blower retainer 26 by inserting a protruding portion 23a containing a motor (not shown) from the first side of the blower retainer 26 into the blower installing hole 35, and then screwing a bolt 37 from the second side of the blower retainer 26.

The socket portion 27 comprises a second end plate 40, a plurality of second axial bodies 41 (four in the present embodiment), and a socket retainer body 42. The second end plate 40 is formed of a flat disk plate, and has said second axial body 41 and the socket retainer body 42 at a first side. The socket retainer body 42 is arranged at the center of the second end plate 40. The second axial bodies 41 are arranged at equal intervals around said socket retainer body 42.

The second axial bodies 41 are each formed in a cylindrical shape, so as to have a size capable of allowing the same to be inserted into said support column 28. Moreover, the second axial bodies 41 are each fixed to the second end plate 40 at the proximal end by welding. The socket retainer body 42 is formed of a U-shaped member, having a socket 43 screwed to the outside of a bottom thereof. The socket retainer body 42 is fixed to the second end plate 40 by welding at a pair of edges 42a. Said lamp 21 is screwed into the socket 43.

First ends of the support columns 28 are fitted from outside to the second axial bodies 41 to have the second axial bodies 41 inserted thereinto, respectively. The support columns 28 are fixed to the second axial bodies 41 by means of the bolts 37 screwed toward the center thereof from the radial direction. A lamp retainer plate 45 having through-holes 45a is brought close from a second side to pass the support columns 28 therethrough. A retainer hole 46 for retaining the distal end of the lamp 21 is formed beforehand in the lamp retainer plate 45. By inserting the distal end of the lamp 21 into the retainer hole 46, the lamp 21 is allowed to have its proximal end fixed by the socket 43 as well as its distal end fixed by the lamp retainer plate 45.

Furthermore, into the support columns 28 are inserted the distal ends 31a of the first axial bodes 31 from the second side 20b, respectively, and the first axial bodies 31 are fixed by means of the bolts 37 screwed toward the center thereof from the radial direction of the support columns 28.

A surface of the blower retainer 26 is abutted, at a first side, to said abutting step 34 by passing the proximal end 31b of the first axial body 31 through the first axis insertion hole 36. Moreover, the first axial body 31 is welded, at its proximal end 31b, to the first side of the first end plate 30 of the ballast installing portion 25 so that the first end plate 30 is fixed. A spacing member 47 is provided between the blower retainer 26 and the ballast installing portion 25.

As discussed above, the holding assembly 20 is constructed such that between the first and second end plates 30 and 40 are stacked, at the first end plate 30 side, the ballast installing portion 25, the blower retainer 26, and the socket portion 27 in sequence, and then they are united together by the support columns 28, thus holding the ballast installing portion 25, the blower 23, and the lamp 27, respectively. Furthermore, the holding assembly 20 is arranged inside the balloon 22 such that a first end 22a of the balloon 22 is fixed by means of a bolt with the same sandwiched between the second fixing plate 48 and the second end plate 40 at its second side, while a second end 22b of the balloon 22 is fixed by means of a bolt with the same sandwiched between the first fixing plate 49 and the first end plate 30 at its second side.

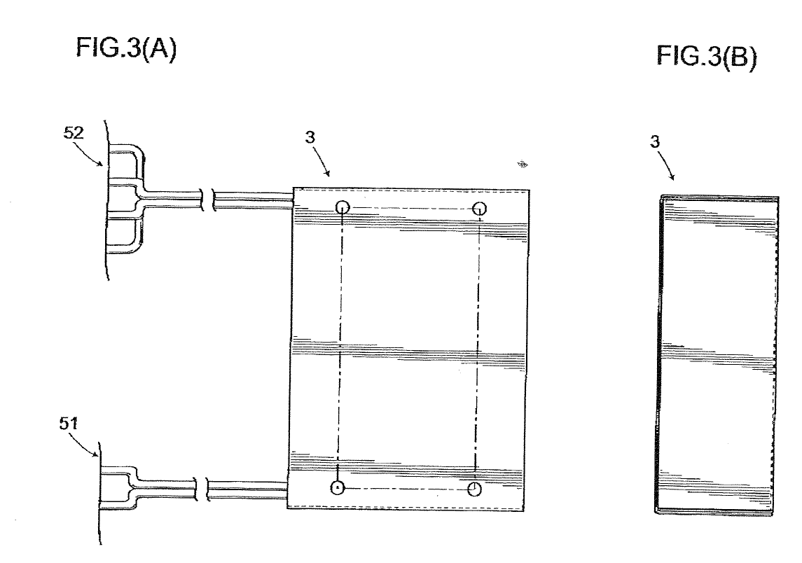

The electronic ballast 3, as shown in FIG. 3, is provided with a circuit substrate (not shown) accommodated in a metallic casing, and two connectors 51 and 52.

It should be noted that neither a cooling fan nor a heat sink block is provided in this electronic ballast 3 unlike the conventional ones, and thus the structural components thereof are miniaturized and simplified, thus achieving the miniaturization of the device as a whole as compared with the conventional ones.

As for the two connectors 51 and 52, the connector 51 is provided with two pins and for use with the lamp 21, while the connector 52 is provided with three pins, and is used for power supply. Employing such structure that eliminates the need of the cooling fan and the heat sink block in this way has enabled the total weight of the electronic ballast 3 to be reduced to about 0.7 kg.

Next is a description of the action and effect of the respective components of the floodlight 1 according to the above-described embodiment of the invention. First, the floodlight 1 is conveyed to an installation site, with the tripod 5 being closed. At that moment, the electronic ballast 3 is mounted in the lighting device 2 and thus the electronic ballast 3 does not become an obstacle to the conveyance, thus enabling the floodlight 1 to be conveyed easily.

Moreover, at the installation site, the floodlight 1 allows the tripod 5 to be unfolded and stand by itself, and then allowing the mast 4 to be extended to thereby hold the lighting device 2 at a predetermined height. At that moment, the floodlight 1 has the electronic ballast 3 mounted in the lighting device 2, and thus the electronic ballast 3 is not exposed to the outside, enabling the improvement of the aesthetic nature thereof.

Under that condition, an activation switch (not shown) is turned on to thereby supply an electric power from a power supply unit (not shown) to the blower 23 and the lamp 21 through the electronic ballast 3. Thus, the blower 23 is allowed to supply air from an external into the balloon 22 through the communication hole 32a. Then, an airflow passage A from the external of the balloon 22 to the blower 23 via the vent hole 32 is established, and the air thus supplied inflates the balloon 22. At the same time, the lamp 21 is allowed to light up. In this way, the floodlight 1 supplies the light of the lamp 21 from the lighting device 2 held at a predetermined height to the surroundings, as mild light transmitted through the balloon 22.

According to the conventional floodlights, the electronic ballast 3 has been installed at a site comparatively near the ground, and thus the distance from the electronic ballast 3 to the balloon light source has been long. As a result, it has been necessary for the conventional floodlights to elongate a cable for electrically connecting the former to the latter. For this reason, a large voltage drop has sometimes occurred in the conventional floodlights, resulting to the failure to light up the balloon light source.

According to the floodlight 1 of the present invention, the electronic ballast 3 is installed in the lighting device 2, and thus the distance of the electronic ballast 3 to the lamp 21 is short, and the cable which electrically connects the electronic ballast 3 to the lamp 21 also becomes short. Accordingly, a resistance between the electronic ballast 3 and the lamp 21 can be reduced in the floodlight 1, thus enabling a voltage drop to be reduced as compared with the conventional ones. Thus, the floodlight 1 enables the lamp 21 to be lighted up more reliably.

Moreover, the floodlight 1 of the present invention allows said ballast installing portion 25 to hold said electronic ballast 3 in the course of the airflow passage A for the air fed into by said blower 23 through said vent hole 32 from the exterior of said balloon 22. Thus, the floodlight 1 enables the electronic ballast 3 to be cooled down by the air fed by the blower 23 into the balloon 22. Accordingly, the floodlight 1 of the present embodiment can control temperature rise in the electronic ballast 3, even if the electronic ballast 3, unlike the conventional ones, does not include any heat-sink block with a radiating fin or any heat-dissipation fan.

Furthermore, said ballast installing portion 25 comprises the communication holes 32a which serve to communicate said vent holes 32 with said electronic ballast 3. Thus, the external air fed from the vent holes 32 is capable of being directly fed into the electronic ballast 3, thereby enabling the electronic ballast 3 to be cooled efficiently.

Still further, according to the floodlight 1 of the present embodiment, the blower 23 is arranged between the lamp 21 and the electronic ballast 3, thus allowing the blower 23 to block the radiant heat from the lamp 21. Accordingly, the floodlight 1 makes it possible to prevent the electronic ballast 3 from being heated by the radiant heat from the lamp 21, thereby enabling the controlling of the temperature rise in the electronic ballast 3. Alternatively, the radiant heat may further be controlled by employing a lamp of high luminous efficiency such as a metal halide lamp, for the lamp 21.

Also, the conventional floodlights have required a duplex cable for output of the electronic ballast 3, i.e., for power supply to the lamp 21 and for power supply to the blower 23, respectively, and thus they have required four cables in total.

According to the floodlight 1 of the present invention, however, the electronic ballast 3 is installed in the lighting device 2, and thus it is possible to supply a sufficient electric power even by the duplex (or triplex if an earth cable is also included) cable. Thus, according to the floodlight 1 of the invention, cables to be used can be reduced in size and weight, thus making it easier for a user to handle the same.

The present invention is not limited to the foregoing embodiment, but other various modifications are possible within the scope of the present invention. For example, although the tripod 5 is described as an example of the base in the foregoing embodiment, the present invention should not be limited thereto, and a carrier device equipped with a trolley may be employed instead.

Moreover, although the ballast installing portion 25 and the blower retainer 26 are both described as being installed inside the balloon 22 in the foregoing embodiment, the present invention should not be limited thereto, and both or either one of them may be installed at a site outside and near the balloon 22.

1. A floodlight comprising:
a base;
a telescopic mast having a proximal end supported by said base;
a lighting device provided at a distal end of said mast; and
an electronic ballast that stabilizes electric power and feeds the stabilized electric power to said lighting device,
wherein said lighting device comprises:
a lamp;
a holding assembly that holds said lamp;
a balloon;
a blower that fees air into said balloon; and
a vent hole that communicates an inside of said balloon with an outside thereof, wherein said holding assembly holds said balloon in the center thereof, and comprises:
a socket portion that holds said lamp;
a blower holding portion that holds said blower; and
a ballast installing portion for installing said electronic ballast thereon,
wherein said ballast installing portion holds said electronic ballast in the course of an airflow passage of the air fed by said blower from the outside of said balloon through said vent hole.

2. (canceled)

3. The floodlight according to claim 1, wherein said ballast installing portion comprises a communicating hole that communicates said vent hole with said electronic ballast.

4. The floodlight according to claim 1 or 3, wherein said holding assembly comprises a spacing member provided between said blower holding portion and said ballast installing portion, and said blower holding portion and said ballast installing portion are stacked.
